(19) United States
(12) Patent Application Publication
(10) Pub. No.: US 2005/0047750 A1
(43) Pub. Date: Mar. 3, 2005

(54) Television capable of reading and storing multimedia

(76) Inventor: Chih-Li Wang, Sinjhuang City (TW)

Correspondence Address: RABIN & Berdo, PC, 1101 14TH STREET, NW, SUITE 500, WASHINGTON, DC, 20005, US

(21) Appl. No.: 10/924,921

(22) Filed: Aug. 25, 2004

(30) Foreign Application Priority Data
Sep. 2, 2003 (TW) 92124266

(51) Int. Cl. H04N 5/76; H04N 5/781

(52) U.S. Cl. 386/46; 386/125

(57) ABSTRACT

A television capable of reading and storing multimedia includes a memory device reading unit, a processing unit, a display unit and a storage unit. The memory device reading unit reads a memory device and outputs memory data. The processing unit processes the memory data or a program and then outputs the processed memory data or program. The display unit displays the processed memory data or program, and the storage unit stores the processed program. The invention can provide a more human-oriented operation interface and get rid of the restriction of viewing images using a computer. Thus, the time for viewing the images may be greatly shortened.

This application claims the benefit of Taiwan application Serial No. 92124266, filed Sep. 2, 2003, the subject matter of which is incorporated herein by reference.

### BACKGROUND OF THE INVENTION

1. Field of the Invention

The invention relates to a television, and more particularly to a television capable of reading and storing multimedia.

2. Description of the Related Art

In the age having newly and rapidly developed technologies, electronic apparatuses such as televisions, computers, multimedia storing/reading apparatuses, digital image acquisition apparatuses, and the like, have become a part in the modern life.

FIG. 1 shows a partial circuit block diagram for a conventional television. Referring to FIG. 1, the television 10 includes a cathode ray tube (CRT) monitor 12, a control unit 14, an antenna 16, and a cable 18. The control unit 14 may receive at least one program, such as an analog image signal, via the cable 18 and the antenna 16. The control unit 14 processes the program and outputs the processed program, which is then displayed by the CRT monitor 12. It is to be noted that the control unit 14 only has to process the received program and does not have to possess the strong operation functions as those of a central processing unit of a computer.

In general, the computer can read and store multimedia. For example, a user may use an optical disk drive to read the multimedia on a disk and may also use a hard disk of the computer to store the desired multimedia. However, these storing and reading operations are simple operations, and do not need the advanced component such as the central processing unit.

When the user wants to view the images captured by the digital image acquisition apparatus, he or she usually utilizes a card reader of the computer to read a memory card of the digital image acquisition apparatus, and then views the images stored in the memory card and displayed on a computer monitor. However, because the user only wants to view the images, no image correction has to be executed. It is not worthwhile to use the central processing unit of the computer for such simple operations. In addition, the user has to overcome the problem of compatibility between the card reader driver and the computer, the memory card cannot be read until the computer is booted and the operation system is loaded, and the operation time and waiting time are quite long. Moreover, because the user has to use the suitable application software to display the images, he or she may feel the pressure and scare if he or she is not familiar with the computer operations.

### SUMMARY OF THE INVENTION

It is therefore an object of the invention to provide a television capable of reading and storing multimedia. The television is designed to have a memory device reading unit and a processing unit, and may provide a more human-oriented operation interface and get rid of the restriction of viewing images using a computer. Thus, the time for viewing the images may be greatly shortened.

The invention achieves the above-identified object by providing a television capable of reading and storing multimedia. The television includes a memory device reading unit, a processing unit, a display unit and a storage unit. The memory device reading unit reads a memory device and outputs memory data. The processing unit processes the memory data or a program and then outputs the processed memory data or program. The display unit displays the processed memory data or program, and the storage unit stores the processed program.

The invention also achieves the above-identified object by providing a television capable of reading and storing multimedia. The television includes a memory device reading unit, a processing unit, a flat panel display, a hard disk and an optical disk drive. The memory device reading unit reads a memory device and outputs memory data, and the optical disk drive reads at least one disk and outputs disk data. The processing unit processes the memory data, disk data or program, and then outputs the processed memory data, disk data or program. The flat panel display displays the processed memory data, disk data or program, and the hard disk stores the processed program.

Other objects, features, and advantages of the invention will become apparent from the following detailed description of the preferred but non-limiting embodiment. The following description is made with reference to the accompanying drawing.

### BRIEF DESCRIPTION OF THE DRAWINGS

FIG. 1 shows a partial circuit block diagram for a conventional television.

FIG. 2 shows a partial circuit block diagram for a television capable of reading and storing multimedia according to a preferred embodiment of the invention.

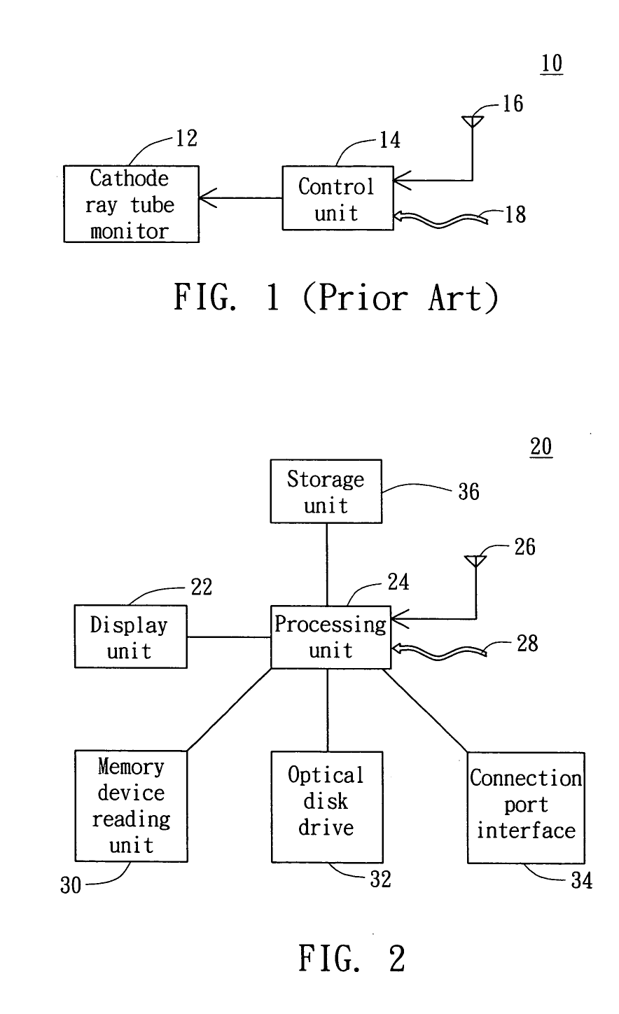

### DETAILED DESCRIPTION OF THE INVENTION

FIG. 2 shows a partial circuit block diagram for a television capable of reading and storing multimedia according to a preferred embodiment of the invention. Referring to FIG. 2, the television 20 includes a display unit 22, a processing unit 24, an antenna 26, a cable 28, a memory device reading unit 30, an optical disk drive 32, a connection port interface 34, and a storage unit 36. The processing unit 24 is electrically connected to the display unit 22, the antenna 26, the cable 28, the memory device reading unit 30, the optical disk drive 32, the connection port interface 34, and the storage unit 36.

The processing unit 24 may receive at least one program via the cable 28 or the antenna 26. The memory device reading unit 30 reads a memory device and outputs memory data. The processing unit 24 processes the memory data or the program, and then outputs the processed memory data or program. The display unit 22 displays the processed memory data or program, and the storage unit 36 stores the processed program or the program that the user is watching.

The processing unit 24 may be a reduced instruction set computer central processing unit (RISC CPU) or an X86 CPU. That is, the television 20 of the invention has a simple computer system, which may process signals inside the typical television. Consequently, when the television is used to show the program, no extra device has to be added in response to the digital or analog signal source in order to satisfy the demands on the processing of future digital television signals.

The memory device reading unit 30 of the invention may be configured in response to the currently popularized digital image acquisition apparatus, such as a digital camera or a digital video recorder/player. First, the user may store the images acquired by the digital image acquisition apparatus in the memory device. Next, the user detaches the memory device from the digital image acquisition apparatus and inserts the memory device into the memory device reading unit 30 of the invention. Then, the user may conveniently and directly view the images, which are stored in the memory device, on the display unit 22 of the invention after the memory device reading unit 30 reads the memory device and the processing unit 24 processes the data read from the memory device. More particularly, the user may store the images, which are displayed on the display unit 22, in the storage unit 36. Consequently, the user may get rid of the restriction of viewing images using a computer. The time for booting the computer and loading the operation system may be saved, and it is unnecessary to use the application software to open the images. Thus, the time for viewing the images may be greatly shortened. Consequently, the invention can provide a more human-oriented operation interface for users who want to view the images but are not familiar with the computer operations.

The memory device read by the memory device reading unit 30 may be a stamp size memory card, such as a secure digital card (SD card), a multimedia card (MMC card), a compact flash card (CF type I/II), a smart media card (SM card), an IBM® Microdrive memory card, a Sony® memory stick, a Sony® memory stick-pro, an xD memory card, and the like.

In addition, the connection port interface 34 is used to be electrically connected to at least one electrical device such that the television 20 of the invention may be synchronously connected to other electrical devices, thereby greatly enhancing the extensibility of the invention. Moreover, the optical disk drive 32 may read at least one disk and output disk data. Then, the processing unit 24 processes the disk data and outputs it to the display unit 22 for display. More particularly, the disk data may be stored in the storage unit 36. The optical disk drive 32 may be, for example, a CD-ROM or a DVD-ROM optical disk drive. Also, the optical disk drive 32 may be an optical disk writer for writing the processed program, the program that the user is watching, or the data in the storage unit 36, into a bare disk placed in the optical disk writer. The optical disk writer may be, for example, a CD-R/W, a DVD-R/W optical disk writer, or the like.

However, one of ordinary skill in the art may easily understand that the technology of the invention is not limited thereto. For instance, the storage unit 36 may be a hard disk. In addition, the display unit 22 may be a cathode ray tube (CRT) monitor or a flat panel display, and the flat panel display may be, for example, a liquid crystal display (LCD) or an organic light emitting diode (OLED) monitor. Also, the connection port interface 34 may be, for example, a universal serial bus (USB), or have a transfer specification of USB or IEEE 1394.

The above-mentioned television capable of reading and storing multimedia according to the embodiment of the invention is designed to have a memory device reading unit and a processing unit, and may provide a more human-oriented operation interface and get rid of the restriction of viewing images using a computer. Thus, the time for viewing the images may be greatly shortened.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A television capable of reading and storing multimedia, the television comprising:
a memory device reading unit for reading a memory device and outputting memory data;
a processing unit for processing the memory data or a program and then outputting the processed memory data or program;
a display unit for displaying the processed memory data or program; and
a storage unit for storing the processed program.

2. The television according to claim 1, wherein the processing unit comprises one selected from the group consisting of reduced instruction set computer central processing unit (RISC CPU) and X86 CPU.

3. The television according to claim 1, wherein the memory device is a stamp size memory card.

4. The television according to claim 3, wherein the stamp size memory card comprises one selected from the group consisting of secure digital card (SD card), multimedia card (MMC card) and smart media card (SM card).

5. The television according to claim 1, wherein the storage unit is a hard disk.

6. The television according to claim 1, wherein the display unit is a cathode ray tube (CRT) monitor or a flat panel display.

7. The television according to claim 1, wherein the processing unit may receive the program via an antenna or a cable.

8. The television according to claim 1, further comprising:
a connection port interface, which is electrically connected to the processing unit, for being electrically connected to at least one electrical device.

9. The television according to claim 8, wherein the connection port interface is a universal serial bus (USB).

10. The television according to claim 8, wherein the connection port interface has a transfer specification of USB or IEEE 1394.

11. The television according to claim 1, further comprising:
an optical disk drive, which is electrically connected to the processing unit, for reading at least one disk, wherein the processing unit processes data on the disk and the display unit displays the processed data on the disk.

12. The television according to claim 1, further comprising:
an optical disk writer, which is electrically connected to the processing unit, wherein a bare disk may be placed in the optical disk writer, and the optical disk writer may write the processed program on the bare disk.

13. A television capable of reading and storing multimedia, the television comprising:
a memory device reading unit for reading a memory device and outputting memory data;
an optical disk drive for reading at least one disk and outputting disk data;
a processing unit for processing the memory data, the disk data or a program and then outputting the processed memory data, disk data or program;
a flat panel display for displaying the processed memory data, disk data or program; and
a hard disk for storing the processed program.

14. The television according to claim 13, wherein the processing unit comprises one selected from the group consisting of reduced instruction set computer central processing unit (RISC CPU) and X86 CPU.

15. The television according to claim 13, wherein the memory device is a stamp size memory card.

16. The television according to claim 13, wherein the flat panel display is a liquid crystal display or an organic light emitting diode monitor.

17. The television according to claim 13, wherein the processing unit may receive the program via an antenna or a cable.

18. The television according to claim 13, further comprising:
a connection port interface, which is electrically connected to the processing unit, for being electrically connected to at least one electrical device.

19. The television according to claim 13, wherein the connection port interface has a transfer specification of USB or IEEE 1394.

20. The television according to claim 13, wherein a bare disk may be placed in the optical disk drive, and the optical disk drive may write the processed program on the bare disk.
